(19) United States
(12) Patent Application Publication
(10) Pub. No.: US 2017/0136928 A1
(43) Pub. Date: May 18, 2017

(54) TRAY ASSEMBLY

(71) Applicant: Dale White, Rootstown, OH (US)

(72) Inventor: Dale White, Rootstown, OH (US)

(21) Appl. No.: 15/342,685

(22) Filed: Nov. 3, 2016

Related U.S. Application Data
(60) Provisional application No. 62/251,241, filed on Nov. 5, 2015.

(51) Int. Cl. B60N 3/00; B60N 3/08

(52) U.S. Cl. CPC B60N 3/002; B60N 3/08

(57) ABSTRACT

A tray assembly for use in a vehicle is provided that includes a platform adapted to have items set on a top surface thereof and a removable fastening assembly that attaches to an arm rest of a vehicle seat assembly.

### CROSS-REFERENCE TO RELATED APPLICATIONS

This application claims the benefit of U.S. Provisional Patent Application Ser. No. 62/251,241 entitled “TRAY ASSEMBLY” filed on Nov. 5, 2015. The entirety of the above-noted application is incorporated herein by reference.

### ORIGIN

The innovation disclosed herein relates to a tray assembly and more specifically, to a tray assembly that attaches to an arm rest on a vehicle seat assembly.

### BACKGROUND

Safety issues are a major concern for the motor vehicle industry for vehicles traveling on the highways and roadways. Distractions to the driver such as talking on a cell phone, texting, eating in the car, etc. tend to increase the probability of an impending accident. If a larger vehicle such as a truck (e.g., a semi), delivery truck, a transit vehicle, a recreational vehicle (RV), etc. is involved the accident tends to be more amplified.

In the trucking industry, in order to save time and money, truckers tend to eat while driving. This creates a distraction because, as in most vehicles, the truck driver has nowhere to place their food and drink. Truck drivers, as most drivers in all types of vehicles, place their food on their lap or in the passenger seat while attempting to eat, which requires both hands thereby increasing the chances of an accident. In addition, truck drivers need to communicate with dispatch and often must write down information while driving. Again, the driver has no means to write on and must use two hands in order to do so.

### SUMMARY

The following presents a simplified summary in order to provide a basic understanding of some aspects of the innovation. This summary is not an extensive overview of the innovation. It is not intended to identify key/critical elements or to delineate the scope of the innovation. Its sole purpose is to present some concepts of the innovation in a simplified form as a prelude to the more detailed description that is presented later.

In an aspect of the innovation, a tray assembly for use in a vehicle is disclosed and includes a platform comprised of a rigid material and being adapted to have items set on a top surface thereof, a removable fastening assembly adapted to attach to an arm rest of a vehicle seat assembly, a connecting device that connects the platform to the fastening mechanism, and a lip defined around a perimeter of the platform whereby the lip is raised with respect to the top surface of the platform.

In another aspect of the innovation, a tray assembly for use in a vehicle is disclosed that includes a platform assembly, a fastening assembly that fastens to an arm rest on a seat assembly in the vehicle, a connecting device that connects the platform assembly to the fastening assembly, and an adjustable container holding assembly.

In another aspect of the innovation, a method of securing a liquid holding container in a vehicle is disclosed that includes providing a tray assembly attached to an arm rest of a seat assembly in the vehicle and having a container holding assembly, actuating an actuator of the container holding assembly moving a distal end of each of the plurality of fingers away from each other, placing a container in an expanded space between the plurality of fingers, releasing the actuator, biasing the second end of the plurality of fingers toward each other, contacting the container with the second end of the plurality of fingers, and securing the container in the container holding assembly.

The following description and drawings set forth certain illustrative aspects and implementations. These are indicative of but a few of the various ways in which one or more aspects may be employed. Other aspects, advantages, or novel features of the disclosure will become apparent from the following detailed description when considered in conjunction with the drawings.

### BRIEF DESCRIPTION OF THE DRAWINGS

The accompanying drawings, which are incorporated in and constitute a part of the specification, illustrate various systems, methods, and other embodiments of the disclosure. Illustrated element boundaries (e.g., boxes, groups of boxes, or other shapes) in the figures represent one example of the boundaries. In some examples one element may be designed as multiple elements or multiple elements may be designed as one element. In some examples, an element shown as an internal component of another element may be implemented as an external component and vice versa.

FIG. 1 is a top perspective view of one example embodiment of a tray assembly in accordance with an aspect of the innovation.

FIG. 2 is a left side top perspective view of the tray assembly of FIG. 1 in accordance with an aspect of the innovation.

FIG. 3 is a left side bottom perspective view of the tray assembly of FIG. 1 in accordance with an aspect of the innovation.

FIG. 4 is a top view of the tray assembly of FIG. 1 in accordance with an aspect of the innovation.

FIG. 5 is a bottom view of the tray assembly of FIG. 1 in accordance with an aspect of the innovation.

FIG. 6 is an end view of the tray assembly of FIG. 1 in accordance with an aspect of the innovation.

FIG. 7 is a top view of the tray assembly of FIG. 1 illustrating a waste strap in accordance with an aspect of the innovation.

FIGS. 8 and 9 are top opposite end perspective views of an alternate example embodiment of an innovative tray assembly in accordance with an aspect of the innovation.

FIG. 10 is a side perspective view of the innovative tray assembly of FIGS. 8 and 9 in accordance with an aspect of the innovation.

FIG. 11 is an end perspective view of the innovative tray assembly of FIGS. 8 and 9 with a telescoping rod partially extended in accordance with an aspect of the innovation.

FIG. 12 is an end perspective view of the innovative tray assembly of FIGS. 8 and 9 with a telescoping rod fully extended in accordance with an aspect of the innovation.

FIG. 13 is a side perspective view of the innovative tray assembly of FIGS. 8 and 9 in a collapsed position in accordance with an aspect of the innovation.

FIG. 14 is a bottom end perspective view of the innovative tray assembly in accordance with an aspect of the innovation.

FIG. 15 is a bottom end perspective view of the innovative tray assembly in the collapsed position in accordance with an aspect of the innovation.

FIGS. 16 and 17 are top and bottom perspective views respectively of the innovative tray assembly attached to a seat assembly in accordance with an aspect of the innovation.

FIG. 18 is a block diagram illustration of a method of securing a liquid holding container in a vehicle in accordance with an aspect of the innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

While specific characteristics are described herein (e.g., thickness, orientation, configuration, etc.), it is to be understood that the features, functions and benefits of the innovation can employ characteristics that vary from those described herein. These alternatives are to be included within the scope of the innovation and claims appended hereto.

While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

In order to overcome the above mentioned problems with drivers of a vehicle, and more specifically, to truck drivers, an innovative tray assembly is disclosed herein in accordance with an aspect of the innovation. The tray assembly can be used as a surface to place objects (e.g., food, glasses, cell phone, etc.) or to use as a writing surface.

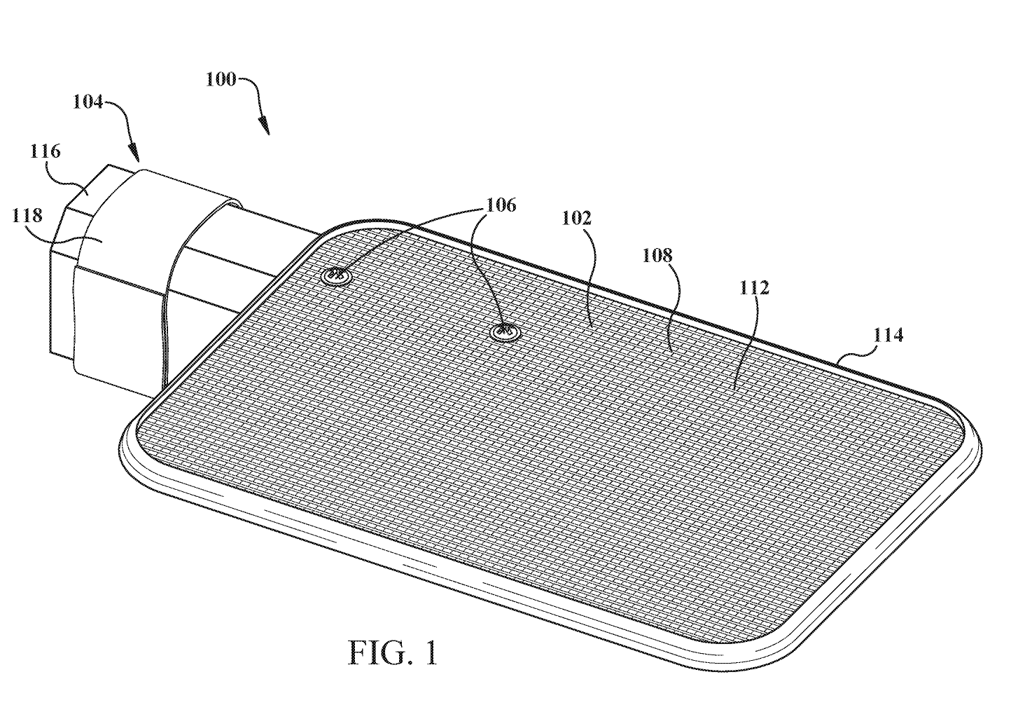

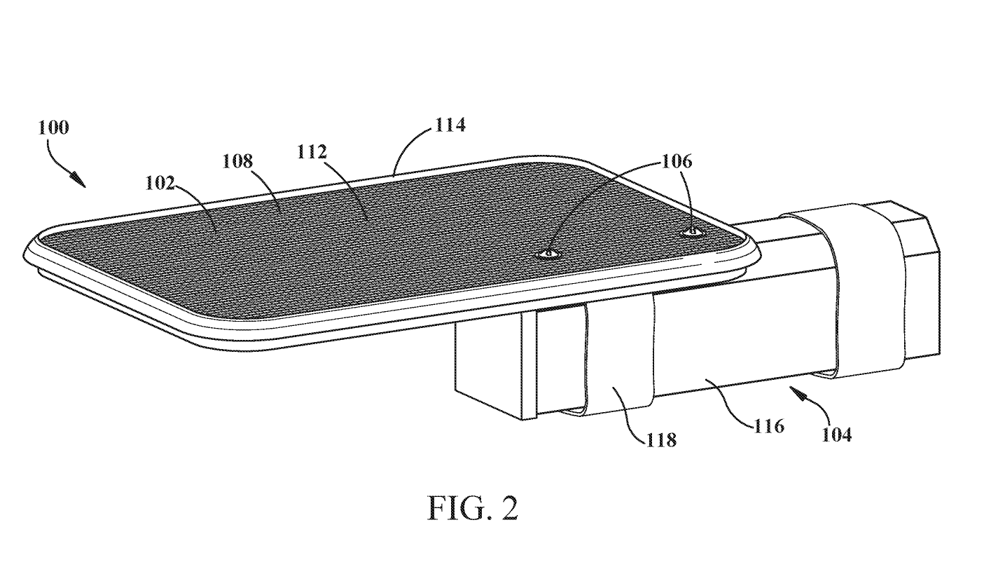

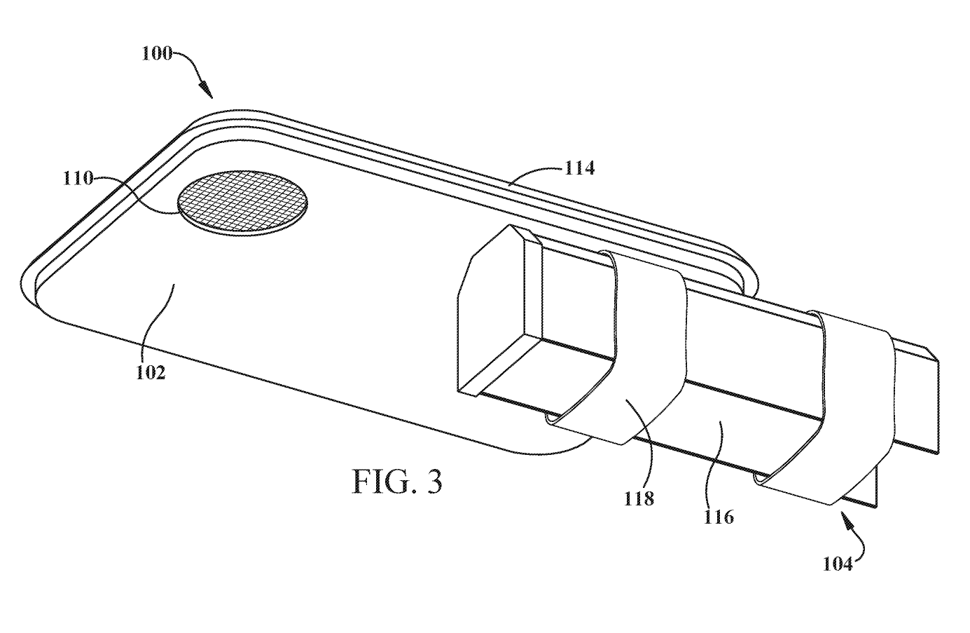

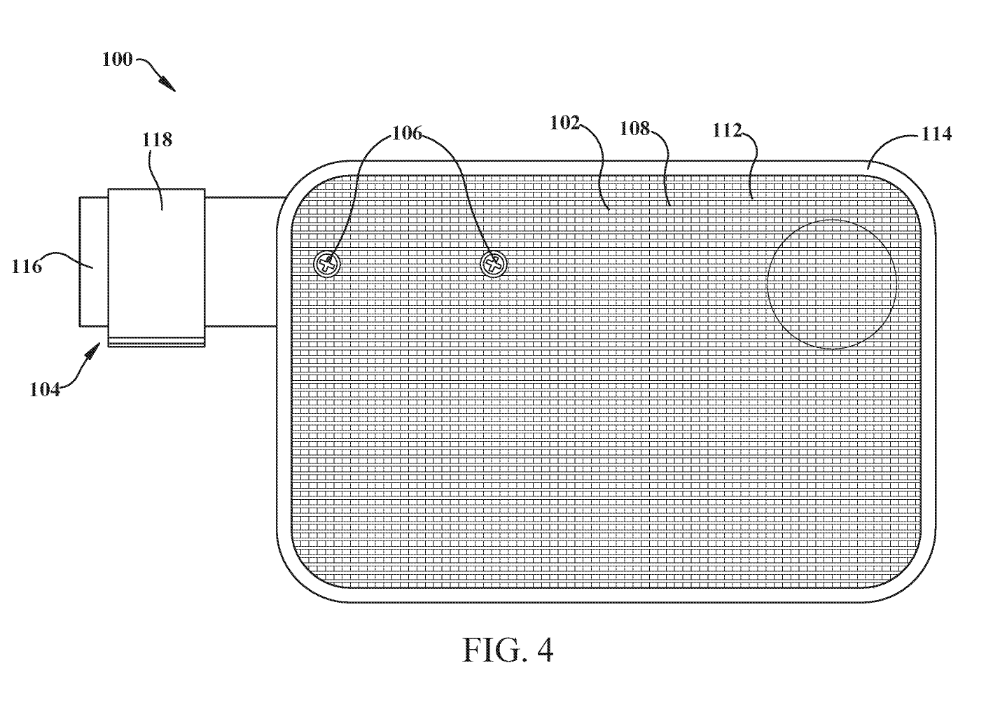

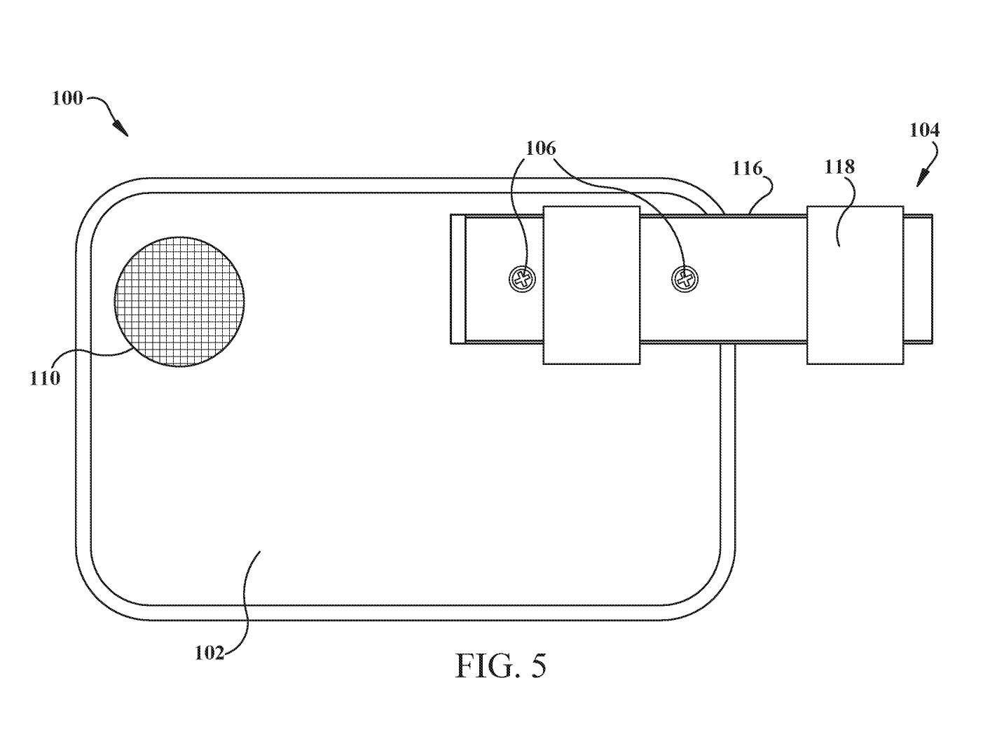

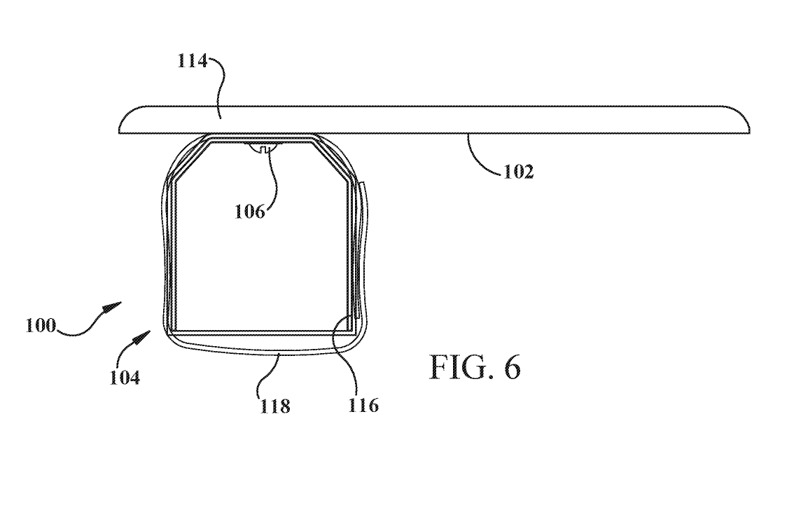

Referring now to the drawings, FIGS. 1-7 illustrate one example embodiment of an innovative tray assembly 100 for use in a vehicle in accordance with an aspect of the innovation. The innovative tray assembly 100 is for use in a vehicle (e.g., truck, RV, etc.) and provides a rigid platform to allow a driver or passenger(s) to place objects (e.g., food, drink, cell phones, glasses, etc.) on while traveling in the vehicle. The tray assembly 100 includes a platform 102, a fastening assembly 104 that removably attaches the platform to a vehicle seat assembly arm rest, and a connecting device 106 that connects the platform 102 to the fastening assembly 104.

The platform 102 is made from a rigid material and is configured to have items (e.g., food, phone, glasses, etc.) set on a top surface 108 thereof. The platform 102 may include an opening 110 to hold a beverage disposed in a container, such as but not limited to a glass, cup, bottle, can, etc. An expandable grommet may be included inside the opening 110 that expands and contracts to adjust to different sized diameter containers. The opening 110 may include a slot to receive the handle of the container (e.g., cup handle). Although the platform 102 is shown as having a rectangular shape with rounded corners, the platform 102 may have any shape, such as but not limited to, a square, polygonal, circular, oval, D-shaped, etc. and may have rounded or squared off corners.

In one embodiment, the platform 102 may be fixedly attached to the removable fastening assembly 104 via the connecting device 106. In other embodiments, the platform may be pivotally attached, slidably attached, may be attached to the removable fastening device 104 such that the platform rotates about a longitudinal axis of the arm rest. In still yet other embodiments, a second platform may be pivotally attached to the first platform 102 and swing outward to provide additional surface area to set items on. In another embodiment, material 112 may be placed on the top surface to provide friction and ease of cleaning.

A lip 114 may be attached to a perimeter of the platform 102 whereby the lip 114 is raised with respect to the top surface 108 of the platform 102 to thereby contain liquid spills and to prevent items from sliding off the platform 102. The lip 114 may be a separate piece from the platform 102 or may be integrated with the platform 102.

The fastening assembly 104 is configured to be removably attached to the armrest of the vehicle seat assembly. The fastening assembly 104 may include at least one U-shaped sleeve 116 made from a semi-rigid or rigid material and a securing mechanism 118 that secures the sleeve 116 to the arm rest. The sleeve 116 may be comprised of a single longer unit that extends nearly a length of the arm rest and wraps around the entire or a portion of the arm rest. In another embodiment, the fastening assembly 104 may include multiple sleeves that are shorter in length and attach to different portions of the arm rest along the length of the arm rest.

The securing mechanism 118 attaches to the sleeve 116 and wraps around the arm rest to thereby secure the sleeve 116 and, hence, the tray assembly 100 to the arm rest. The securing mechanism 118 may be comprised of straps having fasteners (e.g., clips, snaps, buckle, etc.) at each end, Velcro, bungee cords, clamps, tape, rope, etc.

In other embodiments, the fastening assembly 104 may be comprised of at least one clamp, a quick disconnect coupling device, a U-shaped clamp, or any other clamping mechanism that secures the tray assembly 100 to the arm rest.

The connecting device 106 connects the platform 102 to the fastening mechanism 106. The connecting device 106 may be comprised of fasteners, such as but not limited to, screws, nuts and bolts, rivets, adhesive, Velcro, etc. The connecting device 106 may include a swiveling mechanism to allow the platform 102 to swivel with respect to the fastening mechanism 106 and hence, the arm rest. In another embodiment, the platform 102 may be fixedly attached to the fastening assembly 104.

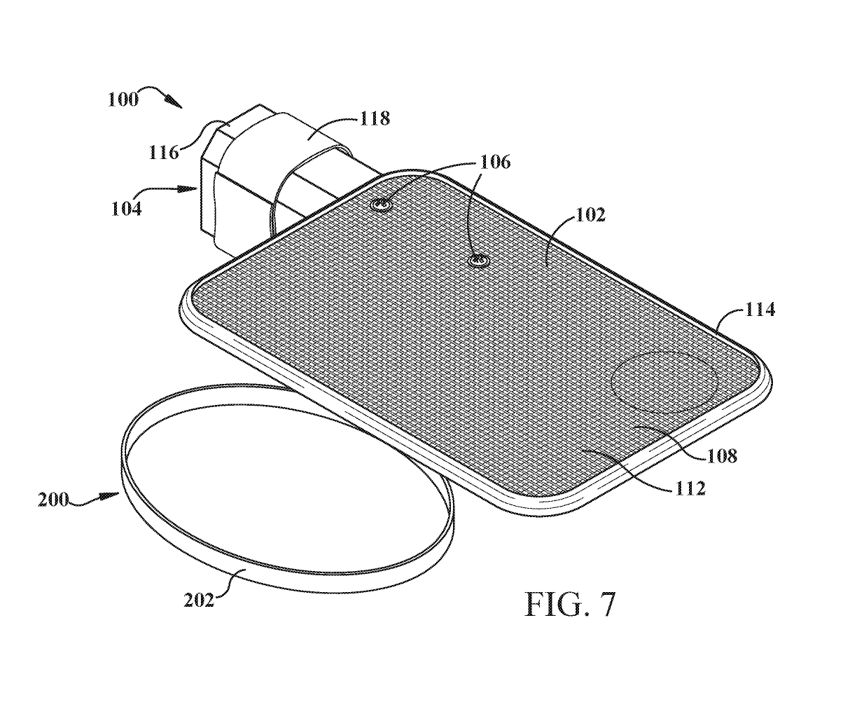

Referring to FIG. 7, the tray assembly may further include a waste assembly 200 that includes a strap 202 removably attached to the platform 103 and a receptacle (e.g., a bag, sack, etc.) attached to the strap 202 to thereby receive waste product.

In other embodiments, the tray assembly may include options, such as but not limited to, a retractable arm having a clip at a distal end thereof to hold items, such as but not limited to a bag of chips, pretzels, candy, paper notes, etc., a detachable ash tray, a holding device to hold items, such as but not limited to, a cell phone, PDA, eye glasses, etc.

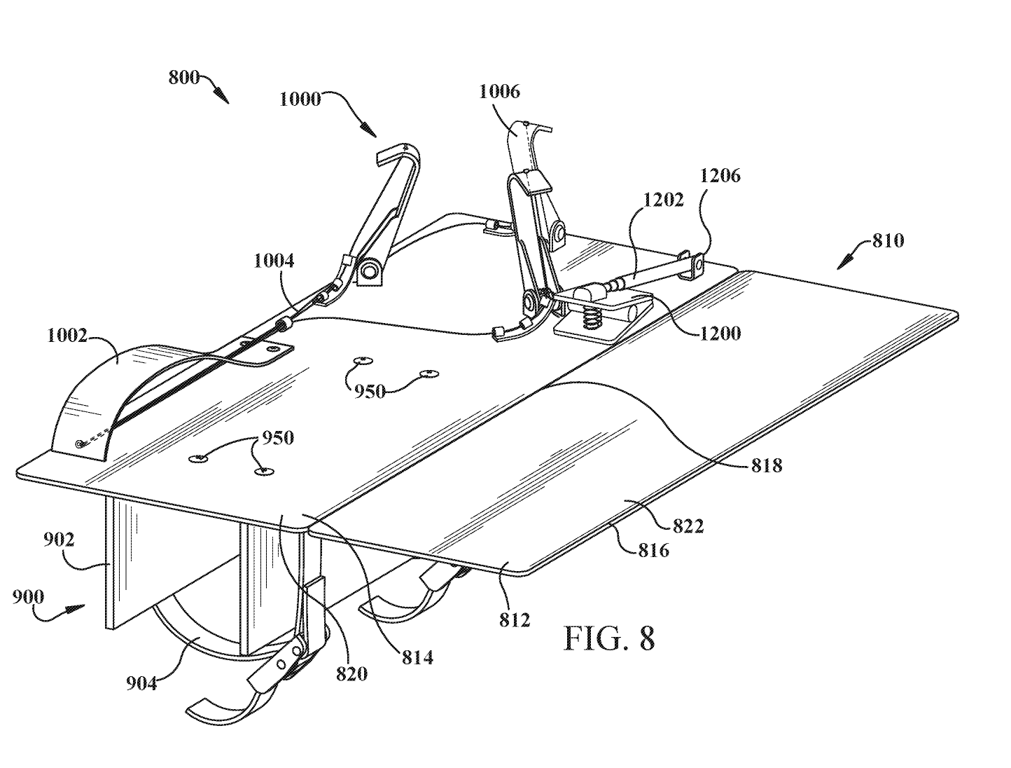

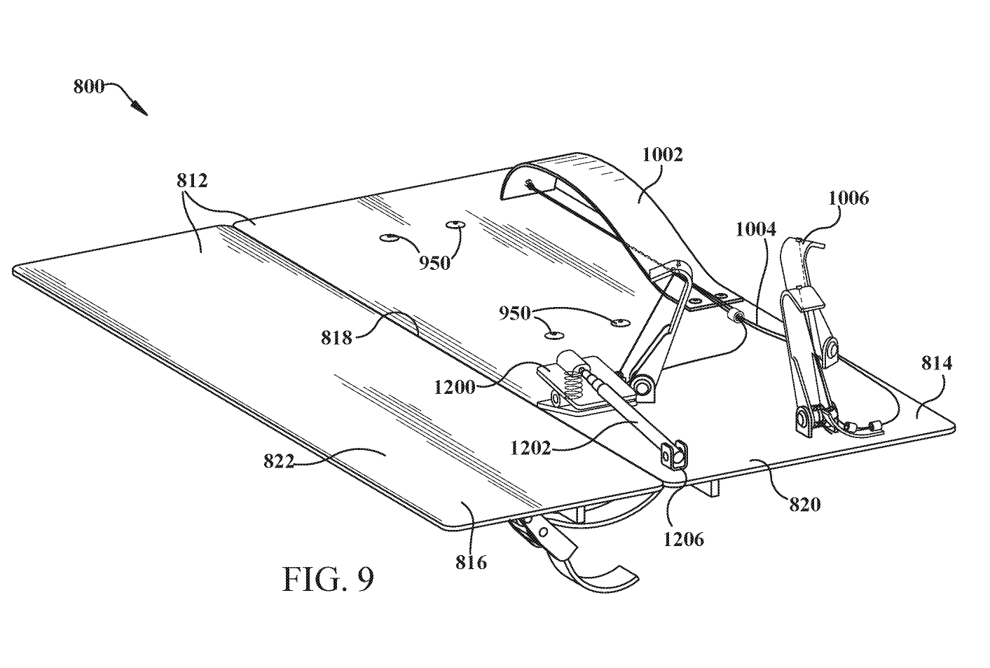

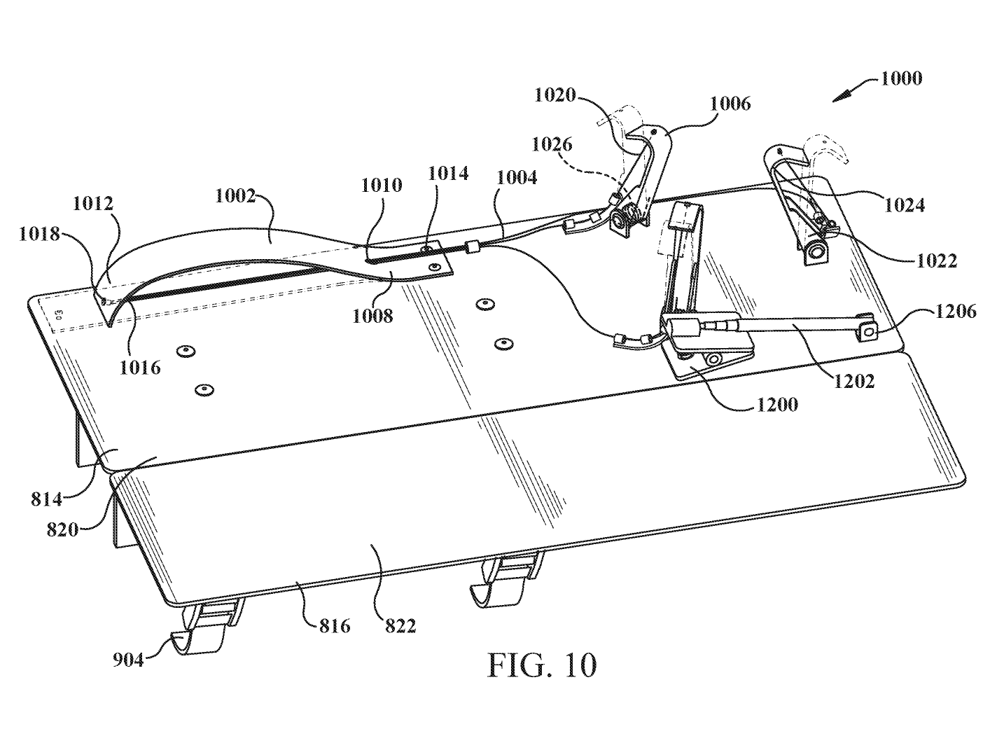

FIGS. 8-18 illustrate another example embodiment of an innovative tray assembly 800 in accordance with an aspect of the innovation. As disclosed above, the tray assembly 800 is configured to attach to an arm rest of a seat, such as an arm rest for a seat assembly in a vehicle, such as but not limited to a truck (e.g., semi, etc.), a recreational vehicle (RV), etc. In this example embodiment, the tray assembly 800 includes a platform assembly 810, a fastening assembly 900, a connecting device 950 that connects the platform assembly 810 to the fastening assembly 900, and a container holding assembly 1000.

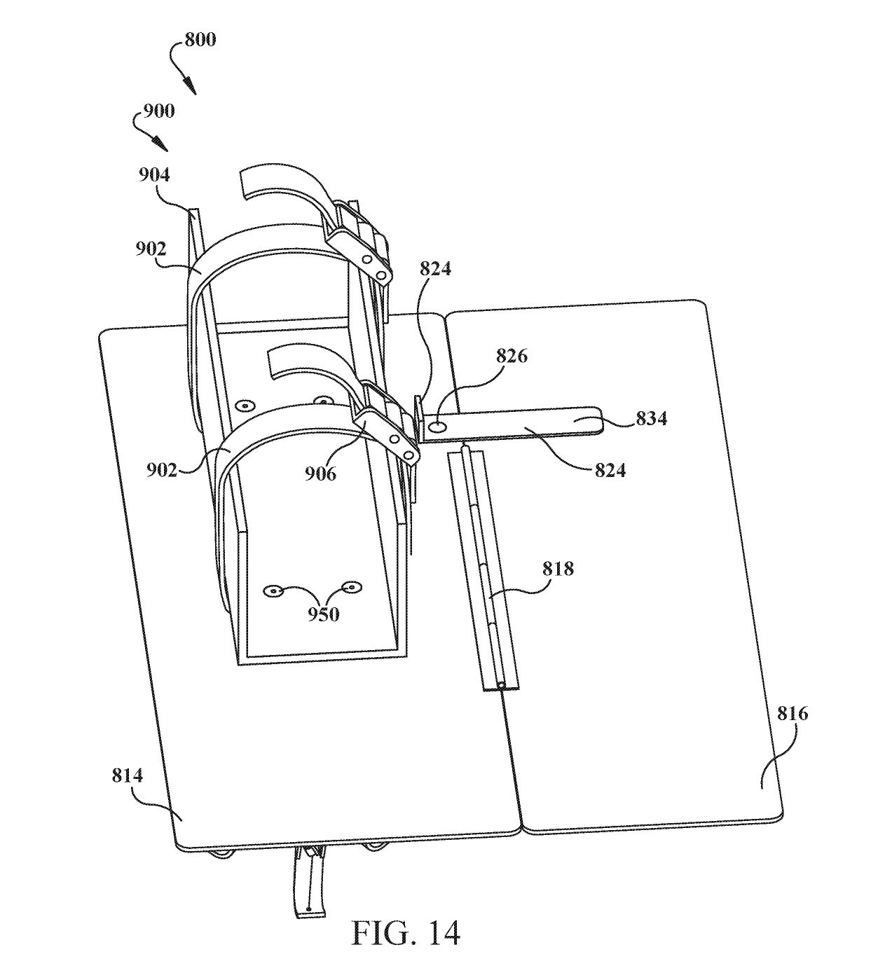

The platform assembly 810 includes a platform 812 that includes a stationary part 814, a movable part 816, and a platform connector 818 that connects the stationary part 814 and the movable part 816, but allows the movable part 816 to move (e.g., pivot, rotate, slide, etc.) with respect to the stationary part 814. Both the stationary part 814 and the movable part 816 may be made from a rigid material, such as but not limited to, plastic, a polymer, metal, etc. In the embodiment illustrated in the figures, the platform connector 818 that connects the movable part 816 to the stationary part 814 is a hinge (best seen in FIGS. 14-16). Thus, in the example embodiment illustrated in the figures, the movable part 816 pivots with respect to the stationary part 814.

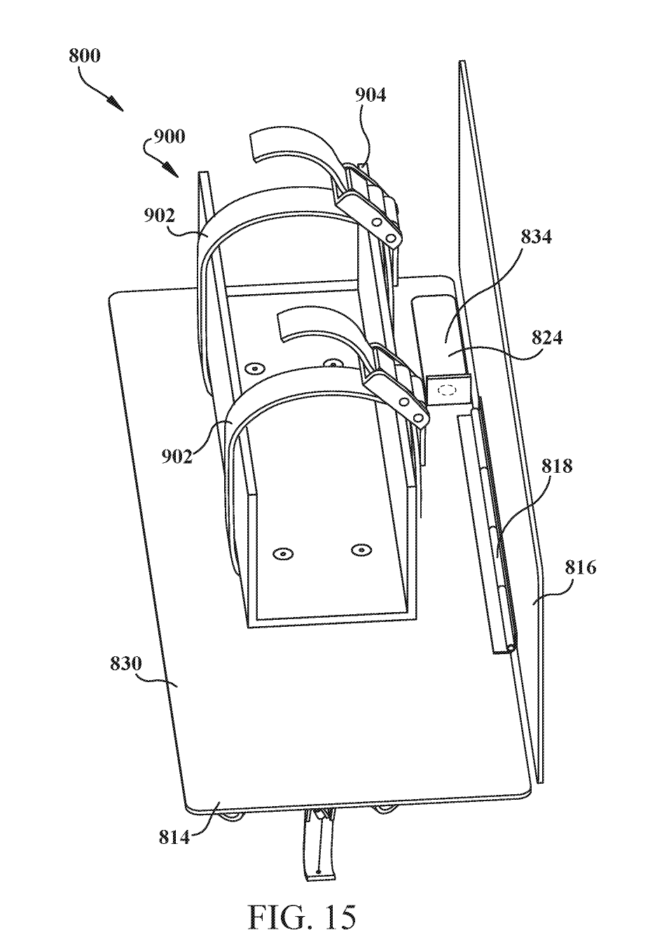

FIGS. 8-12 illustrate the platform 812 in the expanded position whereby a plane (top surface) 820 of the stationary part 814 and a plane (top surface) 822 of the movable part 816 are substantially on the same plane thereby forming a continuous top surface 823 of the platform 812. A locking mechanism 824 (see FIGS. 14 and 15) may be provided to secure the movable part 816 into the platform expanded position. In the example embodiment illustrated in the figures, the locking mechanism 824 is pivotally attached at a pivot point 826 with a fastener 828 (e.g., screw, nut and bolt, rivet, etc.) to a bottom 830 of the platform 812. In this embodiment, the locking mechanism 824 is an L-shaped piece that includes a first part 832 and a second part 834 that is generally perpendicular to the first part 832. The user simply grips the first part 832 and pivots the locking mechanism 824 approximately 90 degrees such that the second part 834 extends across a portion of both the first and second parts 832, 834.

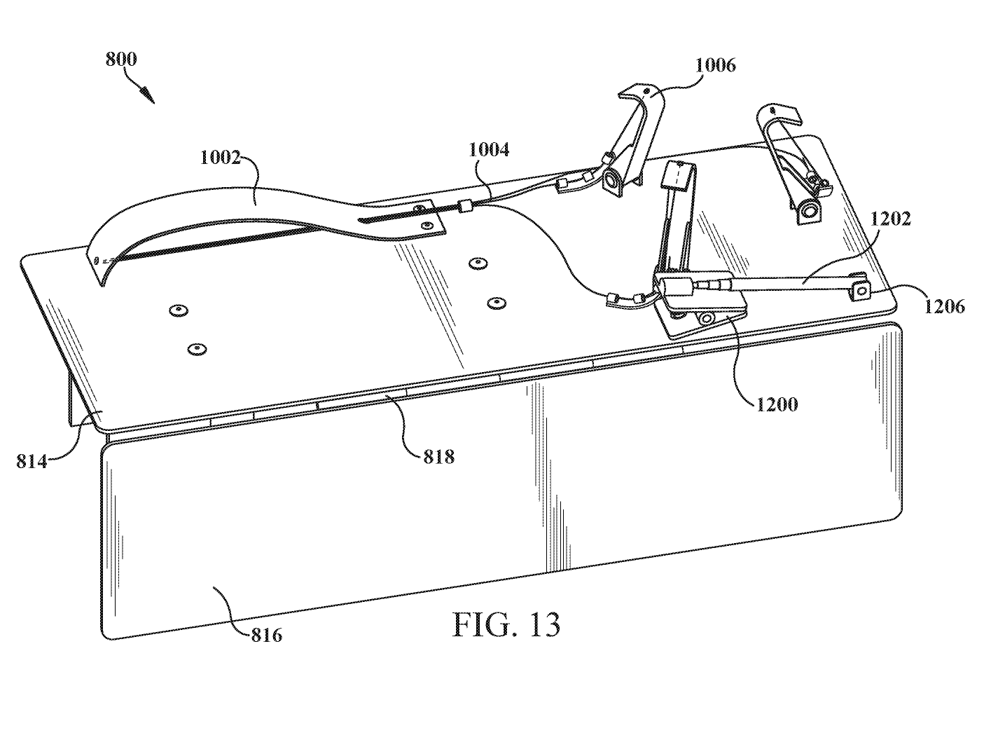

FIG. 13 illustrates the platform 812 in a collapsed position. The collapsed configuration provides a smaller platform for vehicles that have less space for the larger platform 812 in the expanded position or for vehicles that have a manual shift where the shift may interfere with the tray assembly 800. To position the platform 812 in the collapsed position, the user grips the first part 832 of the locking mechanism 824 and pivots the securing mechanism approximately 90 degrees the opposite way such that the second part 834 no longer extends across a portion of the movable part 816 of the platform 812. Rather, the locking mechanism 824 is disposed entirely below the stationary part 814, thus, allowing the movable part 816 the freedom to pivot such that the platform is in the collapsed position. In the collapsed position, the top surface 822 of the movable part 816 is approximately perpendicular to the top surface 820 of the stationary part 814. It should be noted that the locking mechanism 824 can be pivotally attached to the movable part 816 of the platform 812 as opposed to the stationary part 814.

In other embodiments, the platform 812 may be configured such that the movable part 816 may slide into a slot defined in the stationary part 814. In still another embodiment, the movable part 816 may slide underneath the stationary part 814. In still another embodiment, the movable part 816 may be attached to the stationary part 814 at a pivot point such that the movable part 816 may pivot underneath or into the slot defined in the stationary part 814. In still yet another embodiment, the movable part 816 may attach to the stationary part 814 via snaps, fasteners (e.g., nuts and bolts), Velcro™, etc. and, thus, be detachable from the stationary part 814.

Referring to FIGS. 14 and 15, the fastening assembly 900 is configured to be removably attached to the armrest of the vehicle seat assembly. In the example embodiment illustrated in the figures, the fastening assembly 900 may include at least one U-shaped sleeve 902 made from a semi-rigid or rigid material and a securing mechanism 904 that secures the sleeve 902 to the arm rest. The sleeve 902 may be comprised of a single longer unit that extends nearly a length of the arm rest and wraps around the entire or a portion of the arm rest. In another embodiment, the fastening assembly 900 may include multiple sleeves that are shorter in length and attach to different portions of the arm rest along the length of the arm rest.

The securing mechanism 904 attaches to the sleeve 902 and wraps around the arm rest to thereby secure the sleeve 902 and, hence, the tray assembly 800 to the arm rest. The securing mechanism 904 may be comprised of straps having fasteners 906 (e.g., clips, snaps, buckle, etc.) at each end, Velcro, bungee cords, clamps, tape, rope, etc.

In other embodiments, the fastening assembly 900 may be comprised of at least one clamp, a quick disconnect coupling device, a U-shaped clamp, or any other clamping mechanism that secures the tray assembly 800 to the arm rest.

The connecting device 950 connects the platform assembly 810 to the fastening assembly 900. The connecting device 950 may be comprised of fasteners, such as but not limited to, screws, nuts and bolts, rivets, adhesive, Velcro, etc. The connecting device 950 may include a swiveling mechanism to allow the platform assembly 810 to swivel with respect to the fastening assembly 900 and hence, the arm rest. In another embodiment, the platform assembly 810 may be fixedly attached to the fastening assembly 900. In still another embodiment, the tray assembly 800 may be an integrated unit such that the fastening assembly 900 is integrated into the platform assembly 810. In still another embodiment, the sleeve 902 may include a slot defined in a top surface thereof and the platform assembly 810 may include a projection disposed on a bottom surface thereof such that the projection engages the slot to attach and detach the platform assembly 810 to and from the sleeve 902. This allows the user to leave the sleeve 902 attached to the arm rest of the seat assembly for quick attachment and detachment.

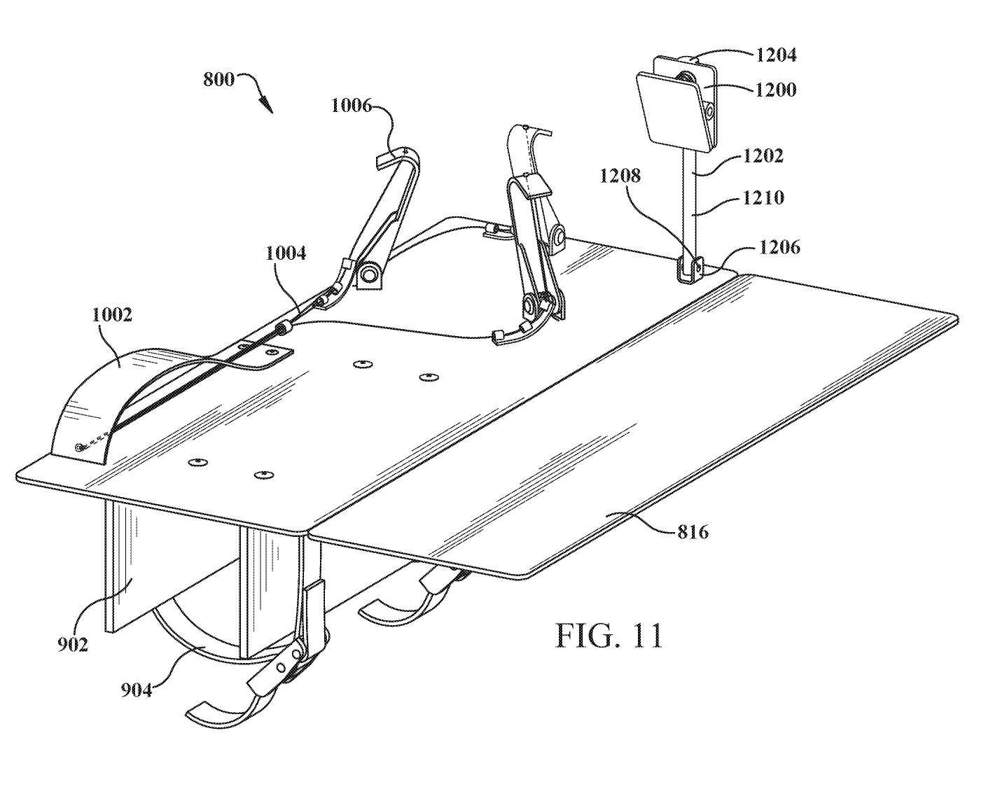

Referring to FIG. 11, the container holding assembly 1000 includes an actuation assembly comprised of an actuator 1002 and one or more actuating connectors (e.g., rod, cable, etc.) 1004, and fingers 1006 configured to grip a container. In the example embodiment illustrated in the figures, the actuator 1002 has an arc shape and is resilient such that when it is de-activated, the actuator will return (is biased) to its non-activated position. The actuator 1002 includes a first end 1008 having an aperture 1010 defined therein and a second end 1012. The first end 1008 of the actuator 1002 attaches to a top of the stationary part 814 of the platform 812 via fasteners 1014 (e.g., screws, nuts and bolts, rivets, etc.). The second end 1012 of the actuator 1002 freely rests on the top surface 820 of the stationary part 814 such that the second end 1012 can be displaced when the actuator 1002 is activated.

The actuating connectors 1004 attach the actuator 1002 to the fingers 1006. The actuating connectors 1004 have a first end 1016 that threads through the aperture 1010 in the actuator 1002 and attaches to the second end 1012 of the actuator 1002 via a fastener 1018 (e.g., screw, nut and bolt, rivet, etc.). A second end 1020 of the actuating connectors 1004 attach to the fingers 1006 to open and close the fingers 1006 as will be subsequently described. In other embodiments, the actuating cables may be located inside the stationary part 814 and actuated by an external actuator.

The fingers 1006 attach to the top surface 823 of the platform 812 and extend in a direction away from the top surface 823 of the platform 812. The fingers 1006 are configured in a circular pattern and are spring loaded and, thus, adapted to grip a container that may be used to hold a drinking liquid of any sized diameter. The example embodiment illustrated in the figures includes three fingers 1006. It is to be understood, however, that the innovation is not dependent on the number of fingers 1006. Any number of fingers 1006 may be used that facilitates securing the container. Thus, the innovation illustrated in the figures and described herein is for illustrative purposes only and is not intended to limit the scope of the innovation.

The fingers 1006 include a first (proximate) end 1022 that attach to the top surface 823 of the platform 812, a second (distal) end 1024 that are adapted to contact and secure the container, and a bias mechanism (e.g., spring) 1026. The first end 1022 may be attached to the stationary part 814 via fasteners (e.g., screw, nut and bolt, rivet, etc.), an adhesive, welding, etc. or may be an integrated piece of the platform 812 and remain stationary during actuation of the container holding assembly 1000. The second end 1020 of the actuating connectors 1004 attach to the second end 1024 of the fingers 1006 to move second end 1024 of the fingers 1006 away from and toward each other during actuation of the container holding assembly 1000. When the container holder assembly 1000 is actuated the second end 1024 of the fingers 1006 move away from each other and when the actuator 1002 is released, the bias mechanism 1026 biases the second end 1024 of the fingers 1006 toward each other, as will be subsequently described.

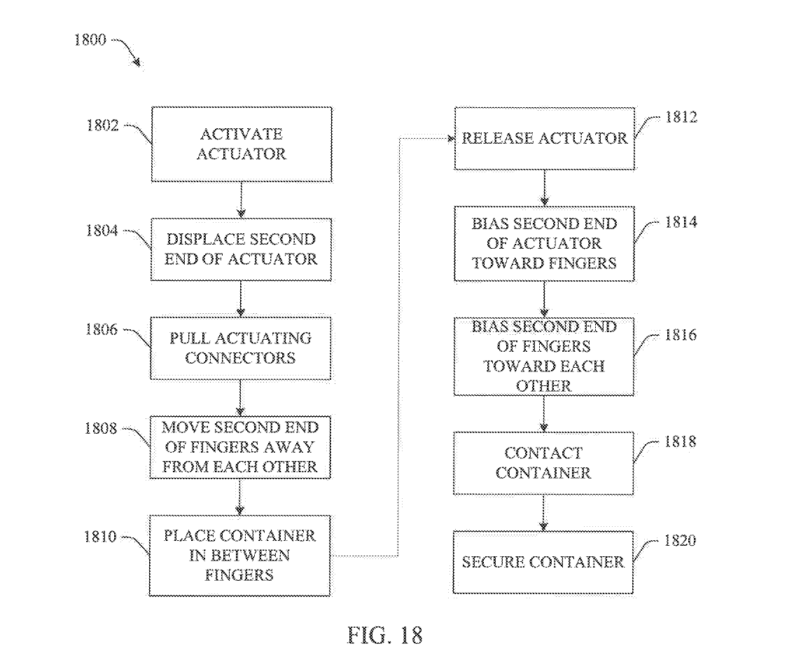

Referring to FIG. 18, a method 1800 of operating the container holding assembly 1000 to secure and remove a container from the fingers 1006 will now be described. At 1802, the user applies pressure to the top of the actuator 1002 to activate the actuator and, hence, the container holding assembly 1000. At 1804, the second end 1012 of the actuator 1002 is displaced away from the fingers 1006. At 1806, the second end 1012 of the actuator 1002 pulls the actuating connectors 1004 in a direction away from the plurality of fingers 1006. At 1808, the second end 1024 of the fingers 1006 move away from each other thus, increasing a distance between the second end 1024 of each of the fingers 1006 (e.g., creating more space between the second end 1024 of the fingers 1006). At 1810, the user places a container into the expanded space between the second end 1024 of the fingers 1006. At 1812, the user releases the actuator 1002. At 1814, the second end 1012 of the actuator 1002 is biased toward the fingers 1006. At 1816, the second end 1024 of the fingers 1006 are biased toward each other by the bias mechanism 1026. At 1818, the second end 1024 contacts the container to thereby at 1820, secure the container into the container holding assembly 1000.

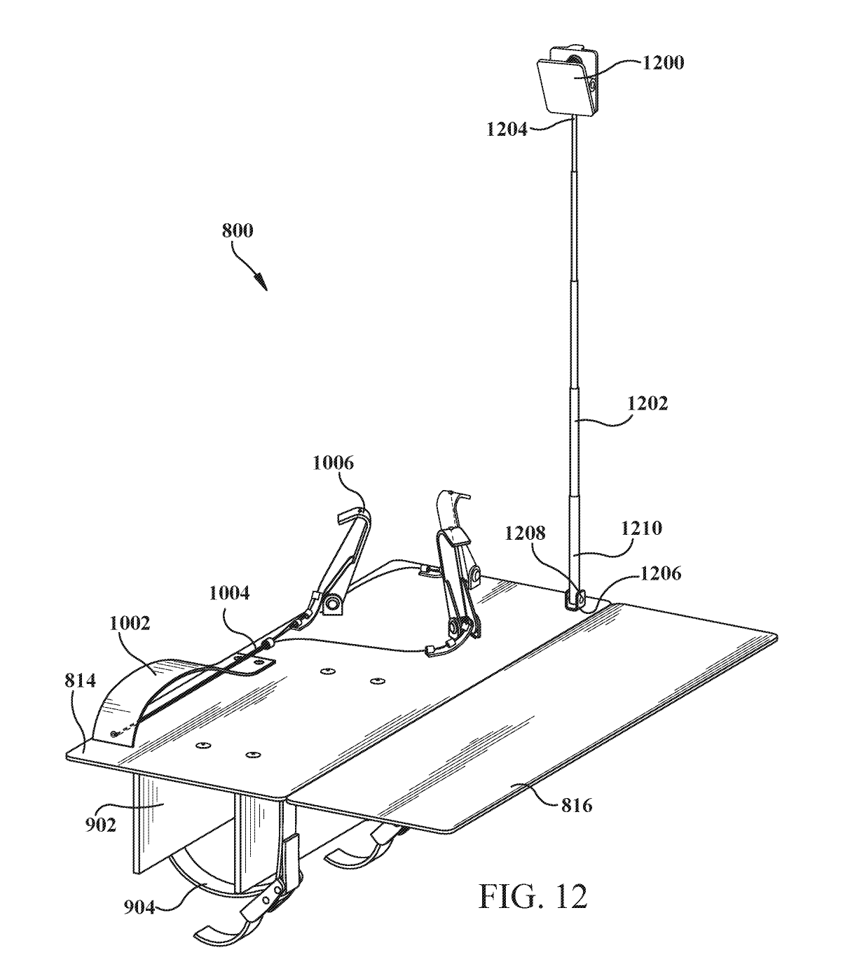

Referring back to FIGS. 12 and 13, the tray assembly 100 may include accessories in accordance with an aspect of the innovation. For example, a clip 1200 may be included to hold an object, such as but not limited to, paper, a bag containing food (e.g., chips, pretzels, etc.), a waste bag, etc. The clip 1200 is a spring loaded clip that is actuated by pressing opposite sides together at an open one end, thus, opening the closed (opposite) end of the clip 1200 to insert the object. The clip 1200 can include a mechanism that facilitates receiving the object without having to press together the opposite sides. For example, the clip can include a cam like device that allows the user to simply slide the object into the closed end of the clip 1200 without having to use two hands. Thus, the driver can keep one hand on the steering wheel. The cam can include teeth to secure the object. To disengage the object the user simply presses the open together to release the object.

The clip 1200 may be attached to a telescoping rod 1202 that attaches to the top surface 823 of the platform 812. The telescoping rod 1202 includes a first (proximate) end 1204 that attaches to the top surface 823 of the platform 812 via an attachment device 1206. The telescoping rod 1202 connects to the attachment device 1206 at a pivot point 1208 via a fastener (e.g., screw, nut and bolt, rivet, etc.). Thus, the telescoping rod 1202 pivots with respect to the top surface of the platform 812, as illustrated in the figures. In another embodiment, the telescoping rod 1202 can rotate with respect to the top surface 823 of the platform 812. The telescoping rod 1202 further includes a second (distal) end 1210. The clip 1200 attaches to the second end 1210 of the telescoping rod 1202. In another embodiment, a light may be disposed on the clip 1200 or on or near the second end of the telescoping rod 1202.

In other embodiments, the tray assembly may include detachable accessories, such as but not limited to, a phone holder, an ash tray, a waste bag holder, an eye glass holder, writing utensil holder, etc. In still other embodiments, the tray assembly may be modular. Thus, additional accessories can be added or removed as desired. In addition, the entire tray assembly disclosed herein can be modular such that the platform assembly 810, the fastening assembly 900, the connecting device 950 that connects the platform assembly 810 to the fastening assembly 900, and the container holding assembly 1000 may be removable or added to the user's desire.

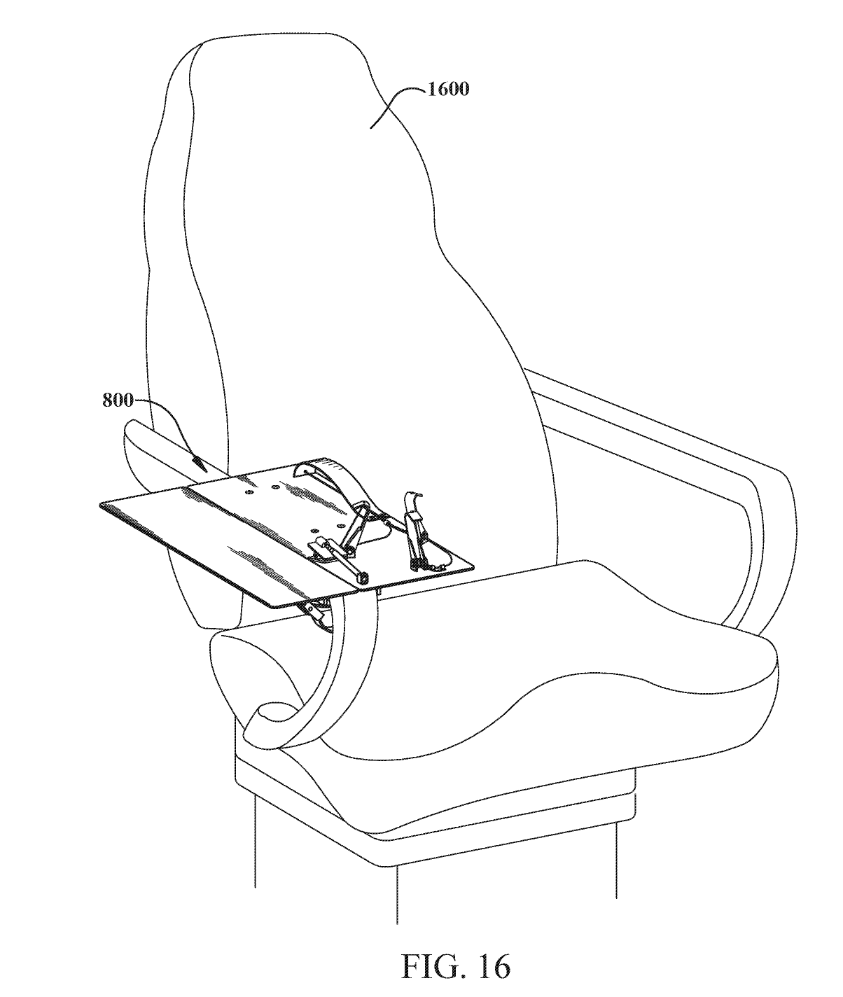

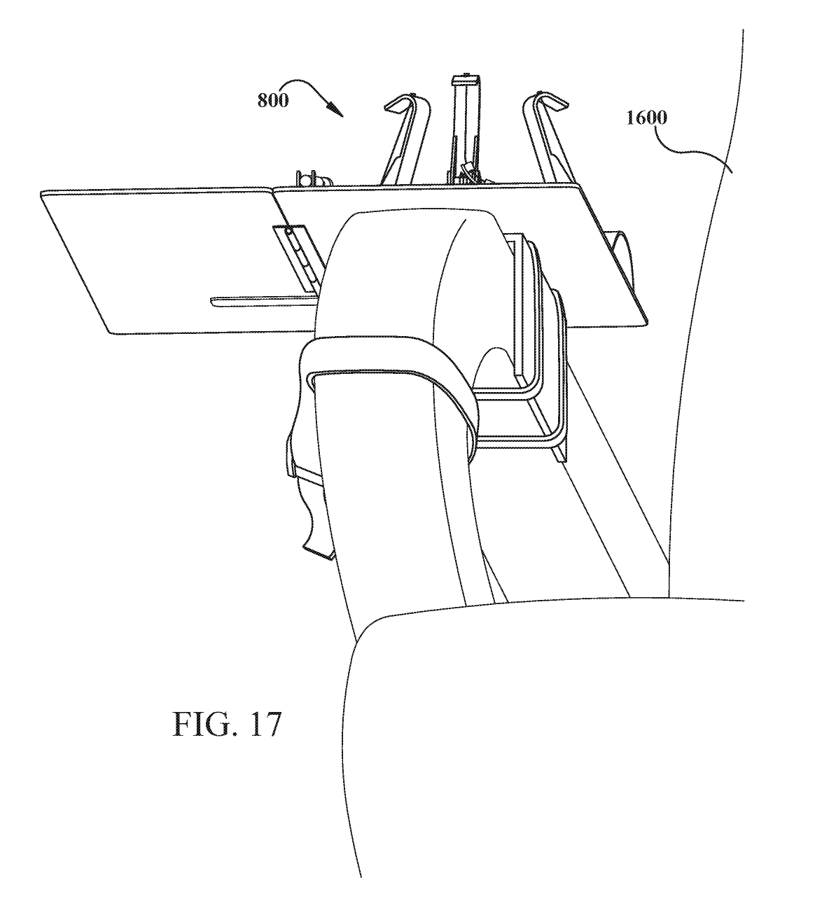

FIGS. 16 and 17 illustrate the innovative tray assembly 800 attached to a seat assembly 1600 and, more specifically, to an arm ret 1602 of the seat assembly in accordance with an aspect of the innovation. As illustrated and described herein, the tray assembly 800 fits over the arm rest via the fastening assembly to thereby provide a place for the driver (and passengers) to place objects thereon or use as a writing surface.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A tray assembly for use in a vehicle comprising:
a platform comprised of a rigid material and being adapted to have items set on a top surface thereof;
a removable fastening assembly adapted to attach to an arm rest of a vehicle seat assembly;
a connecting device that connects the platform to the fastening mechanism; and
a lip defined around a perimeter of the platform whereby the lip is raised with respect to the top surface of the platform.

2. The tray assembly of claim 1, wherein the platform is pivotally connected to the removable fastening mechanism via the connecting device.

3. The tray assembly of claim 1 further including an opening defined in the platform adapted to receive a container.

4. The tray assembly of claim 1 further comprising a waste assembly including strap attached to the platform and a receptacle attached to the strap to thereby receive waste product.

5. The tray assembly of claim 1 wherein the removable fastening assembly includes a guide, at least one securing mechanism, and a fastener to secure the at least one securing device to the arm rest.

6. The tray assembly of claim 5, wherein the at least one securing mechanism is one of a clamp, Velcro, tape, string, tie cord, bungee cord, and strap and the fastener is one of a buckling device, clip, and snap.

7. A tray assembly for use in a vehicle comprising:
a platform assembly;
a fastening assembly that fastens to an arm rest on a seat assembly in the vehicle;
a connecting device that connects the platform assembly to the fastening assembly; and
an adjustable container holding assembly.

8. The tray assembly of claim 7, wherein the platform assembly includes a stationary part and a movable part that is movable with respect to the stationary part.

9. The tray assembly of claim 8, wherein when the platform assembly is in an expanded position the stationary part and the movable part are on a same plane thereby forming a continuous surface.

10. The tray assembly of claim 9, wherein when the platform assembly is in a collapsed position a top surface of the movable part is substantially perpendicular to a top surface of the stationary part.

11. The tray assembly of claim 7, wherein the fastening assembly includes a U-shaped sleeve that removably attaches to the arm rest of the seat assembly and a securing mechanism attached to the U-shaped sleeve that secures the tray assembly to the arm rest.

12. The tray assembly of claim 7, wherein the adjustable container holding assembly includes an actuator, a plurality of fingers configured to secure a container holding a liquid, and actuation connectors that connect the actuator to the plurality of fingers.

13. The tray assembly of claim 12, wherein the actuator includes a first end attached to a top of the platform assembly and a second that moves freely on the top of the platform assembly.

14. The tray assembly of claim 13, wherein the plurality of fingers include a first end attached to the top of the platform assembly and a movable second end distal from the top of the platform assembly and wherein the actuation connector includes a first end attached to the first end of actuator and a second end attached to the second end of the plurality of fingers.

15. The tray assembly of claim 14, wherein when the actuator is activated, the second end of the actuator displaces the actuation connectors to move the second end of the plurality of fingers away from each other thereby increasing a distance between each of the plurality of fingers.

16. The tray assembly of claim 7 further comprising a telescoping rod attached to a top surface of the platform assembly and a clip configured to hold an object attached to a distal end of the telescoping rod.

17. A method of securing a liquid holding container in a vehicle comprising:
providing a tray assembly attached to an arm rest of a seat assembly in the vehicle and having a container holding assembly;
actuating an actuator of the container holding assembly;
moving a distal end of each of the plurality of fingers away from each other;
placing a container in an expanded space between the plurality of fingers;
releasing the actuator;
biasing the second end of the plurality of fingers toward each other;
contacting the container with the second end of the plurality of fingers; and
securing the container in the container holding assembly.

18. The method of claim 17, wherein prior to moving a distal end of each of the plurality of fingers away from each other, the method further comprising displacing a second end of the actuator away from a plurality of fingers of the container holding assembly.

19. The method of claim 18, wherein after displacing a second end of the actuator away from a plurality of fingers of the container holding assembly, the method further comprising pulling an actuation connector in a direction away from the plurality of fingers.

20. The method of the claim 19, wherein prior to biasing the second end of the plurality of fingers toward each other, the method further comprising biasing the second end of the actuator toward the plurality of fingers.
